(19) United States
(12) Patent Application Publication
(10) Pub. No.: US 2023/0048051 A1
(43) Pub. Date: Feb. 16, 2023

(54) INSECTICIDE AND PLANT GROWTH PROMOTOR

(71) Applicant: Marrone Bio Innovations, Inc., Davis, CA (US)

(72) Inventors: Timothy Bruce Johnson, Goodview, VA (US); Yves Andre Trepanier, Double Springs, AL (US)

(73) Assignee: Marrone Bio Innovations, Inc., Davis, CA (US)

(21) Appl. No.: 17/880,981

(22) Filed: Aug. 4, 2022

Related U.S. Application Data
(60) Provisional application No. 63/229,757, filed on Aug. 5, 2021.

(51) Int. Cl. A01N 63/20; A01N 43/90; C05G 3/60; C05D 9/02

(52) U.S. Cl. CPC A01N 63/20; A01N 43/90; C05G 3/60; C05D 9/02

(57) ABSTRACT

The present disclosure includes a combination composition comprising UBP and fermentation collected from Burkholderia sp. where the combination provides significantly improved insecticidal and/or plant growth promoting properties when applied to plants and/or seeds.

### CROSS-REFERENCE TO RELATED APPLICATIONS

This application claims priority to U.S. Patent Application Ser. No. 63/229,757, filed Aug. 5, 2021 and is herein incorporated by reference.

### TECHNICAL FIELD OF THE INVENTION

The present disclosure relates in general to the field of compositions and methods of improving insecticidal and/or improving plant growth promotors property of such compositions, and methods of use thereof.

### BACKGROUND OF THE INVENTION

Without limiting the scope of the invention, its background is described in connection with improved insecticide and plant growth promotion compositions derived from the combination of (a). fermentation collected from Burkholderia sp. (which also includes Burkholderia rinojensis A396), and (b). UBP, and methods of use thereof.

Burkholderia sp. A396 is a known bacterium in the art, as disclosed in U.S. Pat. Nos. 9,701,673, 8,822,193, and 9,526,251; all of which are incorporated herein by reference in their entirety. The fermentation collected from Burkholderia sp. A396 is a known insecticide, fungicide, nematicide, and/or herbicide, and can promote plant health and/or plant growth.

UBP or CPFAPH is a plant fertilizer known in the art, as disclosed in U.S. Pat. No. 9,738,567 or 10,077,216, both of which are incorporated herein by reference in their entirety.

It is not known in the art that the fermentation from Burkholderia sp. A396 can be combined with UBP to produce a composition which significantly improve insecticidal property and/or plant growth promoting property. The two components are not known to have the same/similar mode of actions and are generally for different agricultural purposes.

### SUMMARY OF THE INVENTION

The present invention relates to a surprising and unexpected combination that improves insecticidal and/or plant growth promoting properties.

In one aspect, the present disclosure relates to an improved insecticidal and/or plant growth promoting combination composition comprising (a) a whole cell broth, filtrate, supernatant, and/or extract collected from the fermentation of Burkholderia sp.; (b) CPFAPH; and, (c) a carrier, diluent, and/or adjuvant; wherein said improved insecticidal and/or plant growth promoting properties are compared with insecticidal and/or plant growth promoting properties of either (a) or (b) alone.

In an aspect, the improved insecticidal and/or plant growth promoting combination composition includes Burkholderia sp. A396 and/or Burkholderia sp. A396 having NRRL Accession No. B-50319.

In another aspect, the improved insecticidal and/or plant growth promoting combination composition can be formulated as any one of the following formulation types: emulsifiable concentrate (EC), aqueous emulsion (EW), microemulison (ME), suspension concentrate (SC), oil dispersion (OD), capsule suspension (CS), wettable powder (WP), water dispersible granule (WDG), soluble powder (SP), soluble granule (SG), suspension emulsion (SE), flowable concentrate for seed treatment (FS), aqueous solution (AS), and/or ready to use formulation.

Yet in another aspect, the improved insecticidal and/or plant growth promoting combination can also comprise one or more micronutrients comprising boron, cobalt, copper, iron, manganese, molybdenum, EDTA, and/or zinc.

In an aspect, the improved insecticidal and/or plant growth promoting combination composition can further comprises one or more insecticides and/or plant growth promoting agents such as Bacillus sp., Pseudomonas sp., Brevabacillus sp., Lecanicillium sp., non-Ampelomyces sp., Pseudozyma sp., Streptomyces sp., Burkholderia sp., Trichoderma sp., Gliocladium sp., paraffinic oil, tea tree oil, lemongrass oil, clove oil, cinnamon oil, citrus oil, rosemary oil, avermectin, Bacillus thuringiensis, neem oil, azadiractin, spinosads, Chromobacterium subtsugae, eucalyptus extract, Beauveria bassiana, Metarrhizium anisopliae, organophosphorous compounds, carbamates, pyrethroids, neonicotinoids, fenamiphos, aldicarb, oxamyl, carbofuran, avermectin, Paecilomyces lilacinas, Muscodor spp., Bacillus firmus, Pasteuria penetrans, diammonium phosphate, compost teas, seaweed extracts, indole acetic acid, indole butyric acid, naphthalene acetic acid, Pink Pigmented Facultative Methylotrophs, Bacillus spp., Pseudomonads sp., Rhizobia sp., and/or Trichoderma sp.

In an aspect, the present disclosure relates to methods to improve insecticidal and/or plant growth promoting property of a plant and/or seed comprising the step of applying to said plant and/or seed an effective amount of any of the combination compositions comprising (a) a whole cell broth, filtrate, supernatant, and/or extract collected from the fermentation of Burkholderia sp.; (b) CPFAPH; and, (c) a carrier, diluent, and/or adjuvant.

In another aspect, the method to improve insecticidal and/or plant growth promoting property of a plant and/or seed further comprises planting said seeds and/or growing said seeds.

In another aspect, the method to improve insecticidal and/or plant growth promoting property of a plant and/or seed further comprises applying one or more insecticides and/or growth promoting agents to said plants and/or seeds. None limiting examples include Bacillus sp., Pseudomonas sp., Brevabacillus sp., Lecanicillium sp., non-Ampelomyces sp., Pseudozyma sp., Streptomyces sp., Burkholderia sp., Trichoderma sp., Gliocladium sp., paraffinic oil, tea tree oil, lemongrass oil, clove oil, cinnamon oil, citrus oil, rosemary oil, avermectin, Bacillus thuringiensis, neem oil, azadiractin, spinosads, Chromobacterium subtsugae, eucalyptus extract, Beauveria bassiana, Metarrhizium anisopliae, organophosphorous compounds, carbamates, pyrethroids, neonicotinoids, fenamiphos, aldicarb, oxamyl, carbofuran, avermectin, Paecilomyces lilacinas, Muscodor spp., Bacillus firmus, Pasteuria penetrans, diammonium phosphate, compost teas, seaweed extracts, indole acetic acid, indole butyric acid, naphthalene acetic acid, Pink Pigmented Facultative Methylotrophs, Bacillus spp., Pseudomonads sp., Rhizobia sp., and/or Trichoderma sp.

### BRIEF DESCRIPTION OF THE DRAWINGS

For a more complete understanding of the features and advantages of the present invention, reference is now made to the detailed description of the invention along with the accompanying figures and in which:

FIG. 1 denotes trail quality from Example 1. It shows no spatial patterns observed for yield or wireworm attack. High quality trial with low cv and a high amount of variance explained by the treatment factor

FIG. 2 denotes plant vigor from Example 1. Visible differences in vigour are observed for 305EP and 306EP at their two highest dose rates when combined with UBP-140. The vigour in Cruiser is lower than the aforementioned treatments in autumn, slightly rising in spring without reaching 305 and 306 in combination with UBP-140. This is likely a response to the addition of UBP-140 to the treatment mix.

FIG. 3 denotes autumn plant count from Example 1. Significant differences are observed from the early growth stages. At 120 and 180 ml the combination of 305EP with UBP-140 reaches similar plant counts to the ones observed under Cruiser. The same phenomenon is observed at 4.7 and 7 ml of 306EP with UBP-140.

FIG. 4 denotes spring plant count from Example 1. Significant differences are observed from the early growth stages. At 120 and 180 ml the combination of 305EP with UBP-140 reaches similar plant counts to the ones observed under Cruiser. The same phenomenon is observed at 4.7 and 7 ml of 306EP with UBP-140.

FIG. 5 denotes wireworm attack from Example 1. The addition of UBP-140 allows 305 and 306 on their two highest dose rates to decrease the wireworm incidence to levels comparable of the commercial check. There is a statistically significant response to UBP-140 at 180 ml of 305 and at both 4.7 and 7 ml of 305. The same pattern is observed in the phytosanitary assessments in autumn.

FIG. 6 denotes yield from Example 1. High yields observed overall (adjusted to 13%). An average yield increase of 6.5% is observed with the addition of UBP-140 to both 305EP and 306EP. 305EP at 120 and 180 ml reaches 3.6% and 14% higher yields, respectively, compared to Cruiser, whereas 306EP at 120- and 180-ml yields 0.3 and 11% higher than Cruiser, respectively. Positive rate responses are observed for 305EP and 203 SC2. 306EP rate response peaks at 4.7 ml.

FIG. 7 denotes a graph of plant yield vs. plant count from Example 1. Plant count does seem to have an influence in yield. Even though several treatments are in the upper end of the seed weight spectrum, it is possible to see 305EP and 306EP in combination with UBP-140 clustered in the high yields and high plant stand area.

FIG. 8 denotes straw yield from Example 1. A similar trend as observed in yield is observed in straw yield. Therefore, not only more yield is obtained, but also more biomass overall.

FIG. 9 denotes grain moisture from Example 1.

FIG. 10 denotes wheat yields in bushels/acre in wireworm from Example 1.

FIG. 11 denotes wheat-% wireworm damage 28 DAP from Example 1.

FIG. 12 denotes wheat—spring plant density—from Example 1.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity but include the general class of which a specific example may be used for illustration. The terminology herein is used to describe specific embodiments of the invention, but their usage does not delimit the invention, except as outlined in the claims.

As used herein, “about” follow by a number means a range plus or minus 50% of such number. For example, “about 10%” means from 5-15%.

As defined herein, “derived from” means directly isolated or obtained from a particular source or alternatively having identifying characteristics of a Substance or organism isolated or obtained from a particular source. In the event that the “source” is an organism, “derived from” means that it may be isolated or obtained from the organism itself or culture broth, suspension or medium used to culture or grow said organism. A compound “derived from” or “obtainable from” means that a compound may be isolated from or produced by a cell culture, whole cell broth, suspension, filtrate, supernatant, fraction or extract.

As defined herein, “whole broth culture”, “whole cell broth”, or “WCB” refers to a liquid culture containing both cells and media from a bacterium. This can be produced by fermenting the bacterium. If bacteria are grown on a plate, the cells can be harvested in water or other liquid, whole culture. The terms “whole broth culture”, “whole cell broth”, and “WCB” are used interchangeably.

As defined herein, “supernatant” refers to the liquid remaining when cells grown in broth or are harvested in another liquid from an agar plate or from a bacterium fermentation that are removed by centrifugation, filtration, sedimentation, or other means known in the art.

As defined herein, “filtrate” refers to liquid from a whole broth culture that has passed through a membrane.

As defined herein, “extract” refers to liquid substance removed from cells by a solvent (water, detergent, buffer, organic solvent) and separated from the cells by centrifugation, filtration or other method.

As defined herein, “metabolite” refers to a compound, substance or by-product of a fermentation of a microorganism, or supernatant, filtrate, or extract obtained from a microorganism that has pesticidal/insecticidal or plant growth promotion activity.

As defined herein, an “isolated compound” is essentially free of other compounds or substances, e.g., at least about 20% pure, at least about 40% pure, about 60% pure, about 80% pure, about 90% pure, about 95% pure, as determined by analytical methods, including but not limited to chromatographic methods, electrophoretic methods. For example, a compound “derived from” a Burkholderia sp. species also encompasses a metabolite.

As defined herein, “carrier” is an inert, organic or inorganic material, with which the active ingredient is mixed or formulated to facilitate its application to plant or other object to be treated, or its storage, transport and/or handling.

The term “diluent” is intended to mean an aqueous or non-aqueous solution with the purpose of diluting the active ingredient.

As defined herein, “modulate” is used to mean to alter the amount of a value. For example, decrease in rate of insect infestation, or increase in plant yield.

As defined herein, “pest infestation” is the presence of a pest in an amount that causes a harmful effect including an insect such as wire worm, a disease or infection in a host population, or emergence of an undesired weed in a growth system.

As defined herein, “pesticide” is a substance derived from a biological product or chemical substance that increase mortality or inhibit the growth rate of plant pests and includes but not limited to nematicides, algaecides, herbicides, insecticides, fungicides, bactericides, and viricides.

As defined herein, “CPFAPH”, “UBP”, “Universal Bio Protector”, “UBP110”, or “UBP140” is a co-polymer of fulvic acid and poly-metallic humates fertilizer as described in U.S. Pat. No. 9,738,567 or 10,077,216, both of which are incorporated herein by reference in their entirety. In brief, CPFAPH refers to a growth enhancing component having a chemical formula of, for example, (C14H12O8)m [C9H8(M1, M2, M3, . . . )O4]n and a schematic structure formula of FA-(M1, M2, M3, . . . )-HA, for example, FA-(K; Na; . . . )-HA, FA-(K; Cu; Zn; . . . )-HA, etc., where FA is fulvic acid, HA is humic acid and M1, M2, M3 . . . are metals. The number 140 or 110 denotes certain formulation of UBP.

As used herein, the term “hydrolyzates” refers to any product of a hydrolysis reaction.

As used herein, the term “chelate” refers to a compound containing a ligand bonded to a central metal atom at two or more points.

As used herein, the term “MW540” refers to chemical molecule FR901228 as known in the art, also known as romidepsin, depsipeptide or FK-228.

As used herein, the terms “206”, “206EP”, “305”, “305EP”, “306”, “306EP”, or “306SC1” (with or without the letter MBI as prefix), all means fermentation product from Burkholderia sp.

A396 which can have insecticidal, fungicidal, nematicidal, herbicidal, and/or plant growth promoting properties. One version is currently being commercially sold as tradenames under Venerate and/or Majestene in the United States and other countries. EP denotes end product and SC1 denote a version of the formulation.

As used herein, the term “203 SC2” means fermentation product from Chromobacterium sp. See U.S. Pat. Nos. 8,715,754 and 9,259,007, the contents of both of which are incorporated herein by reference in their entirety. One version of the fermentation product from Chromobacterium is currently being commercially sold as tradename Grandevo in the United States and other countries as a bioinsecticide. SC2 denotes a version of the formulation.

As used herein, the term “UTC” means untreated control, typically used as a plant standard without any treatment.

As used herein, the term “Ympact” is a trade name referring to a version of UBP with micronutrients as denoted in one embodiment of this disclosure.

As used herein, the term “Cruiser” is a trade name denoting thiamethoxam being commercially sold in the U.S. and/or other countries.

Composition

First Active Ingredient: UBP or CPFAPH

One active ingredient of the present disclosure provides a fertilizer including a mixture of growth enhancing components (referred to herein as a “growth enhancing mixture”). Such components can include, but are not limited to, a co-polymer of fulvic acid and poly-metallic humates (CPFAPH) present in an amount of from about 80% to about 90% by weight, based on a total weight of the fertilizer; macro nutrients (such as, nitrogen (N), phosphorous (P), and potassium (K) compounds) present in an amount of from about 3% to about 7% by weight, based on a total weight of the fertilizer; and secondary nutrients (such as, calcium (Ca), magnesium (Mg), and sulfur (S)) and micro nutrients (such as, zinc (Zn), copper (Cu), manganese (Mn), iron (Fe), and copper (Cu)) present in an amount of from about 3% to about 10% by weight, based on the total weight of the fertilizer. The fertilizer mixture can also include biologically active catalytic trace-metals including, but not limited to, molybdenum (Mo), vanadium (V), cobalt (Co), and nickel (Ni). The biologically active catalytic trace-metals can be present in an amount of from about 1% to about 3% by weight, based on the total weight of the fertilizer.

Some fertilizers have been adjusted to include the use of humates. Humates are naturally occurring materials that are rich in humified organic matter and contain effective humic substances, such as humic acid and fulvic acids. Specifically, humic acid is a powerful promotant of beneficial fungi and can also stabilize nitrogen content in soil, allowing for improved nitrogen efficiency. Humic acid also contains complex phosphates and humates are the only known substance with the ability to hold onto all other nutrients in the soil, which allows for heightened nutrient absorption. Humates contain an auxin-like growth promotant that can enhance cell division and increase the permeability of plant cells, allowing for around twice the nutrient uptake. Research has shown that the presence of humic substances in soil increases soil water retention, provides available carbon to soil, promotes growth of living cells, chelate ions in soil and solubilize hydrocarbons into water phase.

In at least one example, the CPFAPH can be produced through the a liquid-phase oxidation of a mixture of an alkaline agent (including, but not limited to, potassium hydroxide (KOH) and/or sodium hydroxide (NaOH)) and a lignin-containing raw material, (including but not limited to pulp from wood, peat, straw, hay, and the like) having a total dry substance content in pulp of from about 12% to about 20% by weight, based on the total weight of the mixture. The production of CPFAPH can be a multiple stage process. For example, in a first stage pre-oxidation can be carried out at a temperature of from about 50° C. to about 190° C., and a pressure of from about 0.5 mega Pascal (MPa) to about 3 MPa, wherein the reaction mixture is simultaneously treated with an oxygen-containing gas until a pH of from about 10.5 to about 12 is achieved. In a second stage, the process can include an oxidation that can be carried out in at a temperature of from about 170° C. to about 200° C., until pH of from about 8.5 to about 10 is achieved. The production of cellulose using a sulphite process can produce a by-product comprising concentrated solutions of lignosulphonate or lignin containing pulp. The by-product can then be recycled and used as a lignin-containing raw material in a subsequent production process.

In an alternative example, a CPFAPH can be produced through a liquid-phase oxidation of a mixture of alkaline agent solution (including, but not limited to KOH and NaOH) with an alkaline hydrolisate of peat. The production process can take place in multiple steps. In a first step, peat can be processed by hydrolysis using a 0.1 molar (M) (around 0.6%) water solution of KOH and/or NaOH with the mass ratio “alkaline solution-peat” of from about 15:5 to about 7:5 for 72 hours at a temperature of from about 15° C. to about 25° C. and atmospheric pressure (1 atm). A second step can include raising the alkaline agent solution concentration to about 2.0±0.1% and the saturation of the peat pulp by hot air at a temperature of about 90° C. to about 100° C. and atmospheric pressure with the saturation of the reactor working space with air 2.5±0.2 m3/min m3. After about 2.5±0.5 hours of liquid-phase oxidation, the solution of synthesized CPFAPH can be separated from the peat pulp by centrifugation.

In at least one example, the CPFAPH mixture described herein can comprise from about 18% to about 20% by weight dry substances, from about 1% to about 5% by weight ashes, and from about 70% to about 75% by weight organics, based on the total weight of the fertilizer; and have a pH of from about 9 to about 10.

In at least one example, prior to the second step of the process described above, fulvic acid (having an average chemical formula C135H182O95N5S2) and humic acid (having an average chemical formula C187H186O89N9S1) can be introduced into the reaction mixture having nitrogen (N) and sulfur (S). The N and S can function as alloying elements in the finished CPFAPH.

In order to prepare the CPFAPH into the reaction mixture must be introduced specific poly-metallic catalysts which can be in the form of suitable water-soluble compounds. These catalysts can include, but are not limited to, metals that are considered secondary nutrients (such as, calcium (Ca), magnesium (Mg)), and micro nutrients (such as, zinc (Zn), copper (Cu), manganese (Mn), iron (Fe), and the like). The above described metals can remain, at least in part, in the end-solution of CPFAPH in the form of humic chelates.

Chelated nutrients can be beneficial in both seed treatment and foliar application. Plant leaves and seeds can have waxy coatings to help prevent them from drying out. However, the wax can also repel both water and inorganic substances, preventing inorganic nutrients from penetrating the seed or leaf. Metal-organic chelate molecules are able to penetrate the waxy layers. Once absorbed, the chelate can release nutrients to be used by the plant.

The end-product of CPFAPH can contain at least a certain amount of chelated micro nutrients; however chelates having humic ligands are not stable at the high temperatures typically used during the drying processes. Therefore, additional stable chelated micro nutrients can be introduced into the end-product, including the UBP mix. A chelating agent can be prepared having chelated calcium (Ca), magnesium (Mg), zinc (Zn), and copper (Cu) and can also include ethylenediaminetetraacetic acid (EDTA). In the alternative, the preparation of a chelated manganese (Mn) and iron (Fe) can be used as a chelating agent ethylenediamine-N,N′-bis(2-hydroxyphenylacetic acid) (EDDHA). The iron and manganese of the EDDHA chelates are stable in solution having a high pH, even at high temperatures. Such chelated micro nutrients can be produced by variety of well-known methods and are also commercially available from a variety of sources.

The chelated micronutrients can then be introduced into a heated end-product of CPFAPH to form heteromolecular metal complexes having two types of ligands, humic compounds and EDTA or EDDHA ligands. Compared to conventional EDTA and EDDHA chelates, the heteromolecular chelated micronutrients described herein can be more biologically active.

Biologically active trace-metals such as molybdenum (Mo), vanadium (V), nickel (Ni), and cobalt (Co) have been found to play an important role in plant metabolism. Ni, in low concentrations, has been found to fulfill a variety of essential roles in plants, including being a constituent of several metallo-enzymes such as urease, superoxide dismutase, NiFe hydrogenases, methyl coenzyme M reductase, carbon monoxide dehydrogenase, and the like. Therefore, Ni deficiencies in plants can reduce urease activity, disturb N assimilation, and reduce scavenging of superoxide free radical. Cobalt can significantly increase nitrogenase activity and is an essential element for the synthesis of vitamin B12. As such, cobalt can be especially important for crops, such as legumes, due to the ability of symbiotic microorganisms to fix to atmospheric nitrogen.

Second Active Ingredient: A Whole Cell Broth, Filtrate, Supernatant, and/or Extract Collected from Fermentation of Burkholderia sp.

The Burkholderia sp. fermentation can include, but not limited to one or more of the following metabolites: Templamide A, Templamide B, Templazole A, Templazole B, FR901228 and/or FR901465. These can be isolated from the fermentation broth of Burkholderia sp.

In an embodiment, the whole cell broth, filtrate, supernatant, and/or extract collected from fermentation of Burkholderia sp. has/have insecticidal, fungicidal, nematocidal, herbicidal, and/or plant growth promoting properties.

Additional Ingredients

The combination composition can further include another microorganism and/or pesticide (e.g, nematicide, fungicide, insecticide). The microorganism can include but is not limited to an agent derived from Bacillus sp., Pseudomonas sp., Brevabacillus sp., Lecanicillium sp., non-Ampelomyces sp., Pseudozyma sp., Streptomyces sp, Burkholderia sp, Trichoderma sp, Gliocladium sp. Alternatively, the agent can be a natural oil or oil-product having fungicidal and/or insecticidal activity (e.g., paraffinic oil, tea tree oil, lemongrass oil, clove oil, cinnamon oil, citrus oil, rosemary oil).

The composition, in particular, can further comprise another insecticide. The insecticide can include but is not limited to avermectin, Bacillus thuringiensis, neem oil and azadiractin, spinosads, Chromobacterium subtsugae, eucalyptus extract, entomopathogenic bacterium or fungi such a Beauveria bassiana, and Metarrhizium anisopliae and chemical insecticides including but not limited to organochlorine compounds, organophosphorous compounds, carbamates, pyrethroids, and neonicotinoids.

The composition can further comprise a nematicide. The nematicide can include, but is not limited to chemical nematicides such as fenamiphos, aldicarb, oxamyl, carbofuran, natural product nematicide, avermectin, the fungi Paecilomyces lilacinas and Muscodor spp., the bacteria Bacillus firmus and other Bacillus spp. and Pasteuria penetrans.

The combination composition can further combine with other plant growth promoting agents such as synthetic or organic fertilizers (e.g., diammonium phosphate, in granular or liquid form), compost teas, seaweed extracts, and/or growth hormones. Agents such as IAA (indole acetic acid) used in a rooting hormone treatment for transplants, either alone or in combination with plant growth regulators, such as IBA (indole butyric acid) and NAA (naphthalene acetic acid), and microbes growth promoters, such as, for example, PPFM (Pink Pigmented Facultative Methylotrophs), Bacillus spp., Pseudomonads, Rhizobia, and/or Trichoderma can also be added.

In an embodiment, certain inert can be added to the present disclosure's composition. Such inserts can include, but not limited to lists 4(a) and/or 4(b) as published by U.S. Environmental Protection Agency for pesticides. The contents of which are incorporated herein by reference in their entirety.

Micronutrients

In an embodiment, UBP can be combined with one or more micronutrients. Non-limiting examples include boron, cobalt, copper, iron, manganese, molybdenum, and/or zinc.

In an embodiment, UBP can further contain EDTA.

Combination Composition

In an embodiment, the combination composition having the first and second active ingredients as described above, and/or other ingredients, exhibit significantly increased insecticidal, fungicidal, nematocidal, herbicidal, and/or plant growth promoting properties, as compared to one active ingredient alone.

Formulations

UBP Formulation

In at least one example, the liquid end-product of the fertilizer described herein can contain from about 15% to about 25% of dry mass, and the end-product may be packed into containers for agricultural use. In at least one other example, the fertilizer can contain about 20% of dry mass. In at least one example, the fertilizer can include from about 20% to about 50% by weight water soluble fertilizing nitrogen and phosphorus compounds, based on the total weight of the fertilizer. The fertilizer described herein can provide a single source including of all components required to stimulate plant growth. The fertilizer formulation described herein can provide significant conveniences; specifically, use of the fertilizer disclosed herein can eliminate the need for mixing dry and liquid nutrients, as well as other additives at the time of application. The disclosure herein further provides a method of preparing a dry, water-soluble fertilizer to be used in seed treatment and foliar application.

In at least one example, the end-product of fertilizer can be dried, for example, using a vacuum spray dryer, operating at a relatively low temperature (such as, from about 80° C. to about 90° C.). In the alternative, the fertilized can be dried using a contact drum dryer. After drying, the finished fertilizer can appear in the form of dark brown granules having granulometry (ISO) 80% 1-2 mm, pH (6%) 8-10 and bulk density loose 1.2 kg/l.

In at least one example, the components of the growth enhancing mixture can be mixed separately, then added to the end-product of a previously formulated fertilizer. In the alternative, the components of the growth enhancing mixture can be added during the preparation of the fertilizer composition, as described below. The dry components, described in detail above, can be put through a grinding unit and then placed in a mixer. The liquid components, such as, the organic extracts, can be injected, or sprayed, into the mixer, and blended until a substantially homogenous dry mixture is achieved.

The composition described herein can remain in dry form without clumping upon exposure to high moisture levels. The humic substances, polysaccharides, and other carbohydrates can absorb moisture associated with the liquid components to form a stable matrix. Thus, the polysaccharide and carbohydrate components can be provided in dry form when added to the mixer. In additional, the vitamins, growth promoters, and amino acids can also be provided in dry form.

Burkholderia sp. Fermentation and/or Combination Composition Formulation

In the present disclosure, in addition to active ingredients, the composition typically further comprises at least one or more carriers, at least one as additives, such as surfactants. Such surfactants can be known in the art that various surfactants, present in one or multiple of the emulsifiers, dispersants or wetting agents.

Other carriers that, in addition to the above-described surfactants, are known in the art, can be various carriers, specifically, for example: one or more of carbon black, kaolin, diatomaceous earth, clay, talc, bentonite, pumice, titanium oxide, dextrin, mixture of cellulose powder, calcium carbonate, a soluble starch, urea, ammonium fertilizer, mixture of urea and ammonium fertilizer, glucose, maltose, table sugar, anhydrous potassium carbonate, anhydrous sodium carbonate, anhydrous potassium bicarbonate, anhydrous sodium bicarbonate, mixture of anhydrous potassium carbonate and anhydrous potassium bicarbonate, and mixture of anhydrous sodium carbonate and anhydrous sodium bicarbonate;

Such emulsifiers that are known in the art may be a variety of emulsifiers, in particular, the emulsifier may be one or multiple of following: calcium dodecanyl sulfate, lecithin, sorbitan fatty acid ester, polyoxyethylene sorbitan fatty acid ester, polyoxyethylene fatty acid ester, polyoxyethylene fatty acid diester, polyoxyethylene fatty alcohol ether, polyoxyethylene fatty amine, ethoxylated castor oil, polyoxyethylene hydrogenated castor oil, polyethylene glycol fatty acid esters, alkylphenol polyoxyethylene ether, polyoxyethylene alkylphenyl ether, polyoxyethylene dialkylphenyl ether, polyoxyethylene alkylphenyl ether/formaldehyde condensate, polyoxyethylene/polyoxypropylene block polymer ether, polyoxyethylene diphenyl ether, polyoxyethylene benzyl phenyl ether, polyoxyethylene styryl phenyl ether, polyoxyethylene ether silicone, ester type silicones, polyoxyethylene fatty alcohol ethers, fatty alcohol (polyoxyethylene) ether, sodium sulfosuccinate, and alkylphenol polyoxypropylene polyoxyethylene ether.

The dispersant mentioned above can be the art of the various known dispersants, in particular, the dispersant is one or multiple of the following: lignin sulfonate, polyacrylic acid sodium, naphthalene sulfonate, alkylnaphthalene sulfonate, methylene-bis-naphthalene sulfonate, alkylamide taurates, poly-carboxylic acid salt, alkylnaphthalene sodium sulfate, alkylnaphthalene formaldehyde polymer.

The wetting agent mentioned above can be the art of the various known wetting agents, in particular, the wetting agent is one or multiple of the following: sodium lauryl sulfate, secondary alkyl sodium sulfate, sodium dodecyl benzenesulfonate, fatty alcohol polyglycol ether sulfates, and mixture of alkylnaphthalene sulfate with an anionic wetting agent;

The compositions of the disclosure can also contain a variety of commonly used in the art formulation additives, in particular, the formulation additives can be one or multiple of the followings: solvents, co-solvents, thickeners, antifreeze, capsule material, protective agents, defoamers, disintegrating agents and a binder.

Solvents described above may be well known in the art a variety of solvents, specifically, the solvent may be one or multiple of the following: an organic solvent, vegetable oil, mineral oil, solvent oil and water.

Wherein said organic solvent comprises N-methyl pyrrolidone, tetrahydrofuran, dimethylsulfoxide, N, N-dimethyl decanamide, N, N-dimethylformamide, xylene, tetrahydrofurfuryl alcohol, tributyl phosphate, 1, 4-dioxane or cyclohexanone: the vegetable oils includes one or multiple of the following: epoxidized soybean oil, soybean oil, peanut oil, rapeseed oil, castor oil, corn oil and pine oil.

The mineral oils include one or multiple of the following: liquid paraffin, oil, kerosene and lubricants.

The solvent oils include Solvesso 100, Solvesso 150 or Solvesso 200. These solvents can be used as co-solvents.

Antifreeze mentioned above is well known in the art a variety of antifreeze, the present disclosure can use one or multiple of the following: ethylene glycol, propylene glycol, glycerin and urea.

The thickener mentioned above may be the various known art thickeners, in particular, the thickener may be one or multiple of the following: xanthan gum, polyvinyl alcohol, polypropylene glycol, polyethylene glycol, carbon black, diatomaceous earth, kaolin, clay, sodium alginate, aluminum silicate, sodium silicate, carboxymethyl cellulose, hydroxypropyl cellulose and sodium bentonite.

Capsule materials mentioned above may be known in the art a variety of capsule materials, with one or multiple of the following: polyurethane, polyurea or urea-formaldehyde resin.

Protective agents mentioned above may be known in the art a variety of protective agents such as polyethylene alcohol and/or polyglycol.

Antifoaming agent said here can be known in the art the various defoamers, with one or multiple of the following: organosiloxane, tributyl phosphate and silicone.

The present disclosure further provides formulation types of the composition mentioned above. Such formulation types include emulsifiable concentrate (EC), aqueous emulsion (EW), microemulison (ME), suspension concentrate (SC), oil dispersion (OD), capsule suspension (CS), wettable powder (WP), water dispersible granule (WDG). Soluble powder (SP), soluble granule (SG), suspension emulsion (SE), flowable concentrate for seed treatment (FS), aqueous solution (AS) and ready-to-use formulation.

Formulations of the present disclosure may be known in the art in various forms, in particular, it can be emulsifiable concentrate (EC), aqueous emulsions, aqueous suspensions, oil dispersion, capsule suspensions, wettable powders, water dispersible granules agents, soluble powders, soluble granules or micro-emulsions, suspoemulsions (SE), suspension seed formulation (FS), aqueous solution (AS) and ready-to-use formulation (Ready-to-use formulation). The formulation mentioned above can be prepared by conventional methods in the art. For example, The total content of the active ingredient in the emulsifiable concentrate formulation (EC) is from 0.01% to 95% by weight, co-solvent content from 0% to 20% by weight, the emulsifier content is from 1% to 30% by weight, solvent made up to 100%.

The preparation methods of EC formulation mentioned above may comprise of, for example, blending each of the active ingredients, solvents, co-solvent or solubilizers and emulsifiers to make a homogeneous oil phase, therefore, obtain an emulsifiable concentrate formulation (EC).

Aqueous emulsion or microemulsion described in present disclosure comprises by weight: active ingredient from 0.01% to 95%, Emulsifier from 1% to 30%, co-solvent from 0% to 30% 0%, solvent from 1% to 30%, antifreeze from 0% to 10%, thickener from 1% to 10%, made up to 100% with water.

The method of preparing the above-described aqueous emulsions or microemulsions for example, may comprise of blending the active ingredient, an emulsifier, a co-solvent and solvent to form a uniform oil phase: mixing water, thickeners, antifreeze, etc. to obtain a homogeneous the aqueous phase. Under high-speed stirring, the aqueous phase is added to the oil phase or oil phase is added to the aqueous phase, forming well dispersed aqueous emulsion or microemulsion. Wherein the microemulsion is transparent appearance, water emulsion is suspension.

Aqueous suspension described in present disclosure comprises by weight: active ingredient from 0.01% to 95%, surfactants from 1% to 30%, antifreeze from 0% to 10%, thickener from 1% to 5%, made up to 100% with water.

Oil dispersion described in present disclosure comprises by weight: active ingredient from 0.01% to 95%, surfactants from 1% to 30%, thickener from 0.1% to 0.5%, made up to 100% with oil.

The methods of preparation aqueous/oil suspension mentioned above are as follows: use either water or oil as a media, grind the active ingredients, surfactants, thickeners to make fine particles, forming the aqueous or oil suspension.

The soluble granules, soluble powders, water dispersible granules, or wettable powder described in present disclosure comprises by weight: active ingredients from 0.01% to 95%, surfactants from 1% to 30%, make up to 100% with various carriers.

Among them, the preparation of water-dispersible granules, soluble granules are as follows: mix each active ingredient and other carriers and mill them, dry the mixture by spraying drying or boiling drying to obtain final products: or knead the mixed crushed powder with water, granulate with a granulator, final granules are obtained by drying and sieving through 5-60 mesh.

The preparation method of soluble powders and wettable powder described in present innovation is as follows: fully mix each of the active ingredients, various additives and fillers such as other carriers well and mill the mixture with a superfine grinding mill.

The capsule suspension described in present disclosure comprises by weight: active ingredients from 0.01% to 95%, solvents from 1% to 30%, protective agents from 0.1% to 5%, defoamers from 0.05% to 1.0%, capsule material from 1% to 30%, dispenser from 1% to 30%, antifreeze from 1% to 10%, thickener from 0.1% to 5%, make up to 100% with water.

The preparation method of capsule suspension described in present innovation is as follows: mix the solvent with capsule material; add the active ingredients to form a mixture; add such a mixture into another mixture consisting of protective agent, antifreeze, defoamer and water to emulsify, stir the mixture until polymerization is completed, then thickener, dispenser and wetting agents are added to form a stable capsule suspension.

The compositions of the present disclosure can be provided in a form of finished formulations, i.e. the compositions of each substance have been mixed: can also be provided in a single formulation form, mixed in a tub or tank themselves prior to use, the concentrates are usually mixed with water to give the desired concentration of the active ingredients.

Application Methods

Applicable Plants

The compositions of the present disclosure can be used in a variety of crops or seeds of such crops, such as cucumbers, pumpkin, zucchini, tomatoes, onions, green onions, beets, peppers and other vegetables: wheat, cereals, rice and other row crops: mung bean, tobacco, flax and other economic crops: strawberries, grapes, citrus and other fruit crops or trees: peony, chrysanthemum, roses and other flowers and other ornamental and garden plants.

The composition disclosed herein can be readily adapted for application by methods including, but not limited to, drip irrigation, hydroponics, and aeroponics. Prior to seed treatment, the dry composition can be dissolved in pure water (for example, non-chlorinated water) to form the solution with a mass concentration of about 0.2% to about 1.0% by weight, based on a total weight of the fertilizer solution. In an alternative example, the mass concentration can be from about 0.2% to about 2.0% by weight, based on a total weight of the fertilizer solution. Seeds can be soaked in the fertilizer for several hours prior to planting.

In at least one example of foliar application the composition can be administered in an amount ranging from about 0.05 to about 0.25 kg per hectare in the form of a water solution with mass concentration from about 0.02% to about 0.15% and about 0.05%. In another example, the composition can be administered in an amount ranging from about 0.1 to about 0.5 kg per hectare. In a third example, the composition can be administered in an amount ranging from about 0.045 pounds per acre to about 0.225 pounds per acre. In a fourth example, the composition can be administered in an amount ranging from about 0.09 pounds per acre to about 0.45 pounds per acre. In fifth example, the composition can be administered in an amount of about 0.135 pounds per acre. In a sixth example, the water solution can have a mass concentration of about 0.05%. In practice, about 2 to about 4 foliar applications can be applied during vegetation season; however, the frequency of application can be adjusted based on crops and other relevant factors.

In at least one embodiment, the composition can be applied through the use of one or more spray tanks. The composition can be completely water soluble, and compatible with common, commercially available, fertilizers and pesticides. The required amount of enhanced fertilizer, or the present composition, can be added directly into partly filled spray tank under constant agitation.

In an alternative example, the composition can be dried as described above and placed into nutrient solution to be used in drip irrigation, hydrophonics, or aerophonics.

Application of the composition can be adjusted based on crop-specific recommendations, which can affect one or more of the application method, time of application, rate of application, and fertilization formulation. Some crops which can benefit from the application of the fertilizer disclosed herein include, but are not limited to, fruits, grapes, nuts, citrus, coffee, watermelon, potatoes, tomatoes, peppers, cucumbers, row crops (such as cotton, sunflower, corn, wheat, rye, oats, millet, sorghum, rice and soybeans), as well as other edible, commercial, and ornamental plants.

The compositions disclosed herein an be applied using methods known in the art. For example, these compositions may be applied to plants or plant parts. Plants are to be understood as meaning in the present context all plants and plant populations such as desired and undesired wild plants or crop plants (including naturally occurring crop plants). Crop plants can be plants which can be obtained by conventional plant breeding and optimization methods or by biotechnological and genetic engineering methods or by combinations of these methods, including the transgenic plants and including the plant cultivars protectable or not protectable by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include harvested material, and vegetative and generative propagation material, for example cuttings, tubers, rhizomes, offshoots and seeds.

Treatment of the plants and plant parts with the compositions set forth above may be carried out directly or by allowing the compositions to act on their surroundings, habitat or storage space by, for example, immersion, spraying, evaporation, fogging, scattering, painting on, injecting. In the case that the composition is applied to a seed, the composition may be applied to the seed as one or more coats prior to planting the seed using one or more coats using methods known in the art.

Alternative application method of the composition of the present disclosure can be, prior to or after insect appearance, applying it to plants or their growth environments with conventional methods such as soil mixing, spraying, dipping, drenching . . . etc., its application rate can be adjusted according to climate condition and/or crops. Under certain circumstances, 1-1000 g/mu is applied. The application concentration can be from 0.001 to 1000 mg/L, diluted with water for example.

In one embodiment, the composition of the present disclosure can be coated on any plant seed(s), either one active ingredient at a time and/or two one active ingredients simultaneously. The improved properties can exhibit in the plant(s) growing from said coated seed(s).

In another embodiment, the composition can be applied on any plants via tank premixes, tank mixes, or separately/individually, either one active ingredient at a time and/or two one active ingredients simultaneously. The improved properties can exhibit in the plant sprayed with the combination afterwards.

Insects

Phytopathogenic insects controlled by the method and compositions of the present disclosure include but are not limited to insects from the order (a) Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseolafusca, Cadra cautella, Carposina nipponensis, Chilo spp., Choristoneura spp., Clysia ambiguella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiella, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; (b) Coleoptera, for example, Agriotes spp., Anthonomus spp., Atomaria linearis, Chaetocnema tibialis, Cosmopolites spp., Curculio spp., Dermestes spp., Diabrotica spp., Epilachna spp., Eremnus spp., Leptinotarsa decemlineata, Lissorhoptrus spp., Melolontha spp., Orycaephilus spp., Otiorhynchus spp., Phlyctinus spp., Popillia spp., Psylliodes spp., Rhizopertha spp., Scarabeidae, Sitophilus spp., Sitotroga spp., Tenebrio spp., Tribolium spp. and Trogoderma spp.; (c) Orthoptera, for example, Blatta spp., Blattella spp., Gryllotalpa spp., Leucophaea maderae, Locusta spp., Periplaneta spp. and Schistocerca spp.; (d) Isoptera, for example, Reticulitermes spp.; (e) Psocoptera, for example, Liposcelis spp.; (f) Anoplura, for example, Haematopinus spp., Linognathus spp., Pediculus spp., Pemphigus spp. and Phylloxera spp.; (g) Mallophaga, for example, Damalinea spp. and Trichodectes spp.; (h) Thysanoptera, for example, Frankliniella spp., Hercinotnrips spp., Taeniothrips spp., Thrips palmi, Thrips tabaci and Scirtothrips aurantii; (i) Heteroptera, or example, Cimex spp., Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Tniatoma spp.; (j) Homoptera, for example, Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Paratoria spp., Pemphigus spp., Planococcus spp., Pseudaulacaspis spp., Pseudococcus spp., Psylla spp., Pulvinaria aethiopica, Quadr aspidiotus spp., Rhopalosiphum spp., Saissetia spp., Scaphoideus spp., Schizaphis spp., Sitobion spp., Trialeurodes vaporariorum, Trioza erytreae and Unaspis citri; (k) Hymenoptera, for example, Acromyrmex, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.; (l) Diptera, for example, Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp. and Tipula spp.; (m) Siphonaptera, for example, Ceratophyllus spp. and Xenopsylla cheopis; (n) from the order Thysanura, for example, Lepisma saccharina; and/or (o) wireworm. The active ingredients according to this disclosure can further be used for controlling crucifer flea beetles (Phyllotreta spp.), root maggots (Delia spp.), cabbage seedpod weevil (Ceutorhynchus spp.) and aphids in oil seed crops such as canola (rape), mustard seed, and hybrids thereof, and also in plants such as wheat, rice and/or maize.

In a particular embodiment, the insect may be a member of the Spodoptera, more particularly, Spodoptera exigua, Myzus persicae, Plutella xylostella or Euschistus sp.

### EXAMPLES

### Example 1

Wheat trial against wireworms. One aim of this example is to evaluate performance of 305EP, 306EP, and 203 SC2 in terms of yield, yield components, and tolerance to wireworm attack in comparison to standard seed treatments. Crop: winter wheat. Sowing density: 294 seeds m-2. Trial design: RCBD with 6 replicates. Plot size: 46 m² (Harvested area 42 m²). The Treatment list is denoted in Table 1 below. All treatments include Dividend Extreme as base seed treatment.

TABLE 1

| | | | Rate |
|---|---|---|---|
| Number | Code | Description | (ml cwt⁻¹) |
| 1 | Control | Control | — |
| 2 | Cruiser _ST | Thiamethoxam- | |
| | | based seed treatment | |
| 3 | 305EP_60 | MBI 305EP | 60 |
| 4 | 305EP_120 | MBI 305EP | 120 |
| 5 | 305EP_180 | MBI 305EP | 180 |
| 6 | 305EP_60_UBP140 | MBI 305EP + | 60 |
| | | UBP 14@36 ml cwt⁻¹ | |
| 7 | 305EP_120_UBP140 | MBI 305EP + | 120 |
| | | UBP 14@36 ml cwt⁻¹ | |
| 8 | 305EP180_UBP140 | MBI 305EP + | 180 |
| | | UBP 14@36 ml cwt⁻¹ | |
| 9 | 306EP_2.4 | MBI306EP | 2.4 |
| 10 | 306EP_4.7 | MBI306EP | 4.7 |
| 11 | 306EP_7 | MBI306EP | 7 |
| 12 | 306EP2.4_UBP140 | MBI 306EP + | 2.4 |
| | | UBP 14@36 ml cwt⁻¹ | |
| 13 | 306EP4.7_UBP140 | MBI 306EP + | 4.7 |
| | | UBP 14@36 ml cwt⁻¹ | |
| 14 | 306EP7_UBP140 | MBI 306EP + | 7 |
| | | UBP 14@36 ml cwt⁻¹ | |
| 15 | 203SC2_60 | MBI 203SC2 | 60 |
| 16 | 203SC2_120 | MBI 203SC2 | 120 |
| 17 | 203SC2_180 | MBI 203SC2 | 180 |

Three types of insecticide seed treatment compounds were evaluated: MBI-305EP, MBI-306EP and MBI-203 SC2, at multiple rates for efficacy in controlling wireworms in winter wheat and in combination with UBP-140. All seed in this example included a standard fungicide package such as Dividend Extreme. Treatment 2 is the only seed that should have a commercial insecticide treatment of Cruiser that is applied. Recommended rate a total slurry rate of 7-12 fl. oz./cwt.

Treatments and rates: Untreated Check, Standard=Cruiser (thiamethoxam), MBI-305EP @ 60 ml/cwt=0.854 mg MW540/cwt, MBI-305EP @ 120 ml/cwt=1.71 mg MW540/cwt, MBI-305EP @ 180 ml/cwt=2.56 mg MW540/cwt, MBI-305EP @ 60 ml/cwt+UBP140 @ 36 ml/cwt, MBI-305EP @ 120 ml/cwt+UBP140 @ 36 ml/cwt, MBI-305EP @ 180 ml/cwt+UBP140 @ 36 ml/cwt, MBI-306EP @ 2.4 ml/cwt=0.854 mg MW540/cwt, MBI-306EP @ 4.7 ml/cwt=1.71 mg MW540/cwt, MBI-306EP @ 7.0 ml/cwt=2.56 mg MW540/cwt, MBI-306EP @ 2.4 ml/cwt+UBP140 @ 36 ml/cwt, MBI-306EP @ 4.7 ml/cwt+UBP140 @ 36 ml/cwt, MBI-306EP @ 7.0 ml/cwt+UBP140 @ 36 ml/cwt, MBI-203 SC2 @ 60 ml/cwt, MBI-203 SC2 @ 120 ml/cwt, MBI-203 SC2 @ 180 ml/cwt.

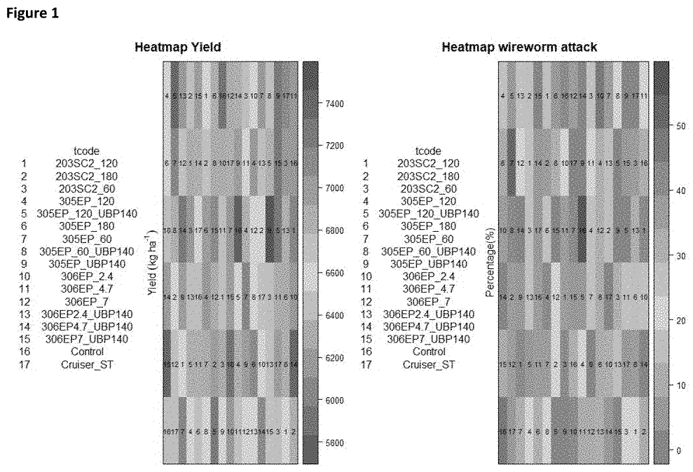

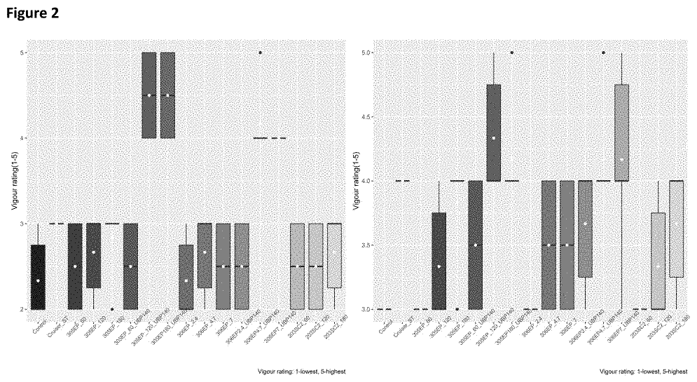

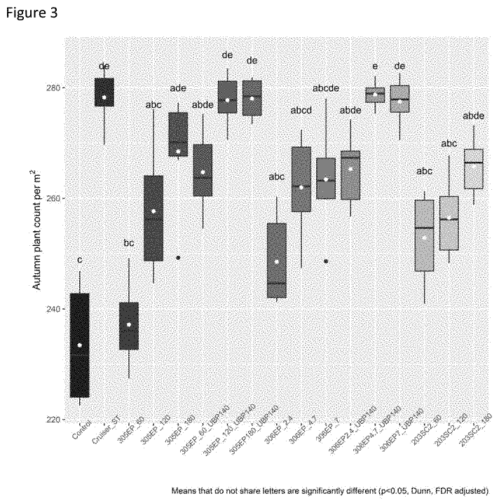

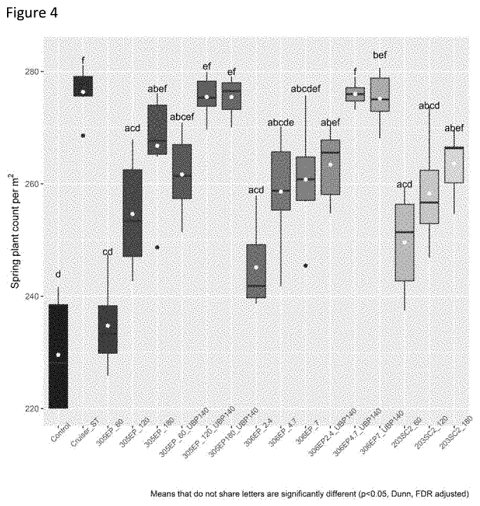

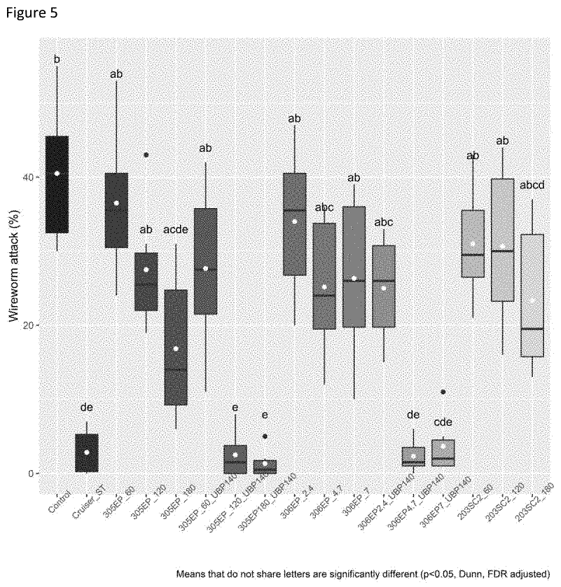

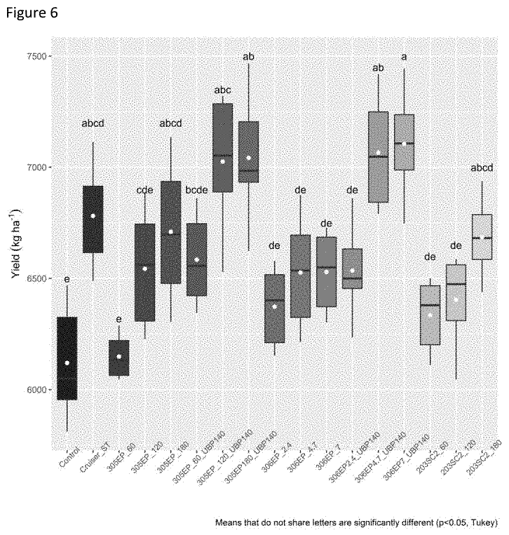

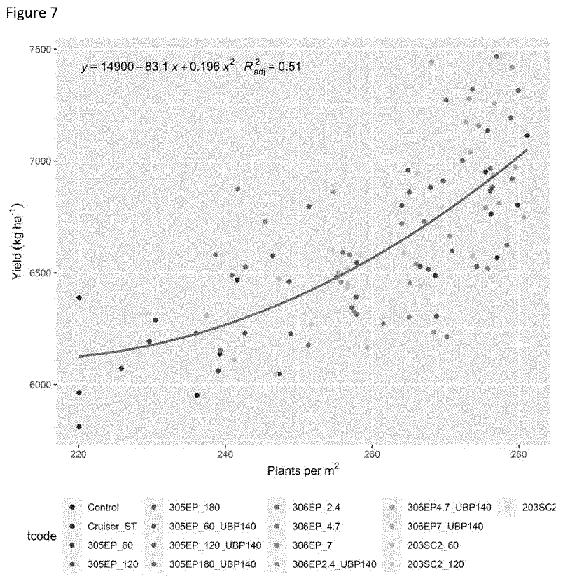

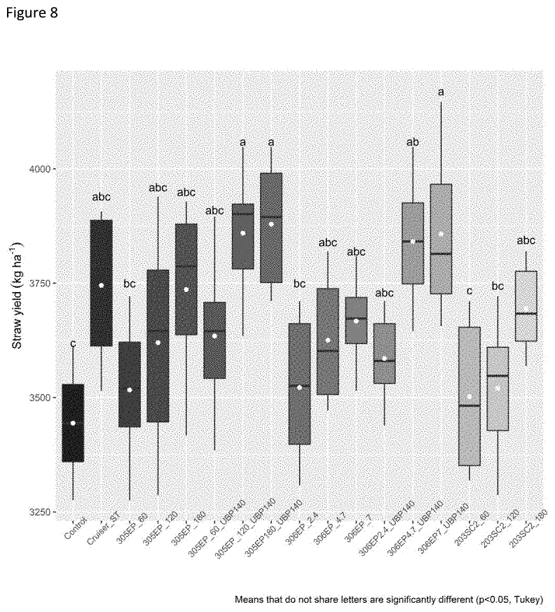

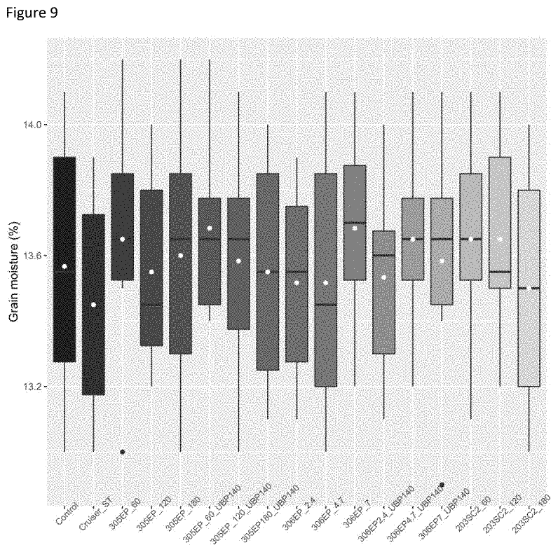

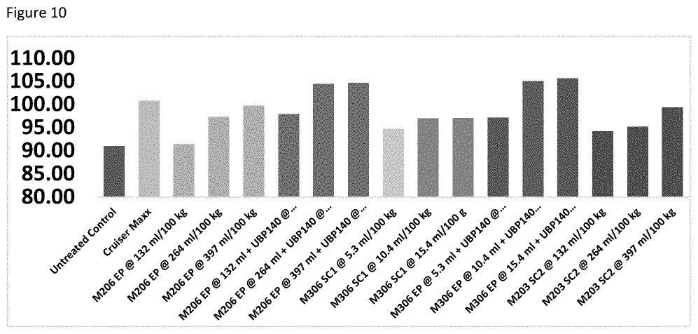

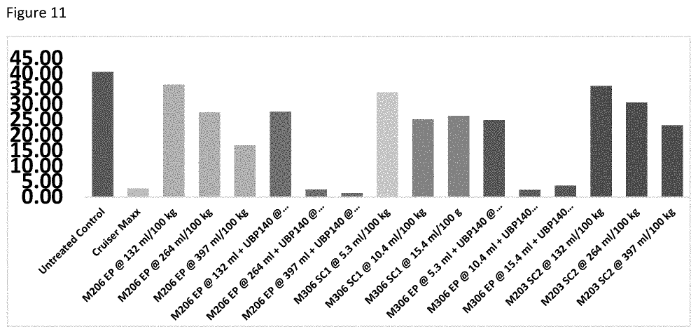

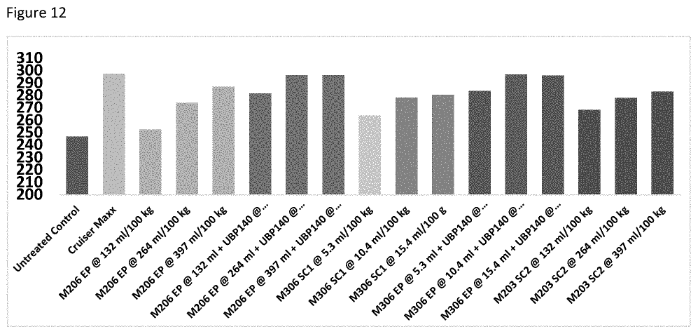

Rates of treatments have the following assumptions regarding concentration: MBI-305EP lot #L1710-01N containing 14.23 ug/ml MW540; MBI-306=363 ug/ml. 10 lbs. of seed were planted a six replication. Additional material was sent for MBI-306EP to allow for a serial dilution: MBI-305EP=200 ml, MBI-306EP=10 ml, MBI-203 SC2=54 ml, UBP140=50 ml. Trial design was RCBD with 6 replications. Plot Size was 10 feet×50 feet. Evaluations done include stand count density pre and post dormancy, plant vigor after germination, evaluation of wireworm feeding and damage four weeks after planting, and final grain yield. Detail results are shown in FIGS. 1-12.

### Example 2

Table 2 below shows an evaluation of the compositions contemplated in this disclosure and their application rates. The results will demonstrate significantly improved insecticide and/or plant growth promotor on any treated plants, seeds, or plants grown from treated seeds.

TABLE 2

| Treatment | Products | 306 rate | | | | Ympact/UBP rate | | | |
|---|---|---|---|---|---|---|---|---|---|
| #1 | fungicide, | 0.0 | fl oz/cwt | — | ml/100 Kg | 1.1 | fl oz/cwt | 72 | ml/100 Kg |
| | herbicide, | | | | | | | | |
| | insecticide | | | | | | | | |
| | and/or | | | | | | | | |
| | nematicide + | | | | | | | | |
| | Ympact | | | | | | | | |
| #2 | fungicide, | 3.5 | fl oz/cwt | 228 | ml/100 Kg | | fl oz/cwt | — | ml/100 Kg |
| | herbicide, | | | | | | | | |
| | insecticide | | | | | | | | |
| | and/or | | | | | | | | |
| | nematicide + | | | | | | | | |
| | MBI-110 | | | | | | | | |
| #3 | fungicide, | 1.0 | fl oz/cwt | 65 | ml/100 Kg | | fl oz/cwt | — | ml/100 Kg |
| | herbicide, | | | | | | | | |
| | insecticide | | | | | | | | |
| | and/or | | | | | | | | |
| | nematicide + | | | | | | | | |
| | MBI-106 12 | | | | | | | | |
| #4 | fungicide, | 0.60 | fl oz/cwt | 39 | ml/100 Kg | | fl oz/cwt | — | ml/100 Kg |
| | herbicide, | | | | | | | | |
| | insecticide | | | | | | | | |
| | and/or | | | | | | | | |
| | nematicide + | | | | | | | | |
| | MBI-306 SCI | | | | | | | | |
| #5 | fungicide, | 0.60 | fl oz/cwt | 39 | ml/100 Kg | 1.22 | fl oz/cwt | 80 | ml/100 Kg |
| | herbicide, | | | | | | | | |
| | insecticide | | | | | | | | |
| | and/or | | | | | | | | |
| | nematicide + | | | | | | | | |
| | MBI-306 SC1 + | | | | | | | | |
| | UBP-140 | | | | | | | | |
| #6 | fungicide, | 0.40 | fl oz/cwt | 26 | ml/100 Kg | 1.22 | fl oz/cwt | 80 | ml/100 Kg |
| | herbicide, | | | | | | | | |
| | insecticide | | | | | | | | |
| | and/or | | | | | | | | |
| | nematicide + | | | | | | | | |
| | MBI-306 SC1 + | | | | | | | | |
| | UBP-140 | | | | | | | | |
| #7 | UTC = untreated | | | | | | | | |
| | control | | | | | | | | |

MBI-106 12 is a commercial product with the trade name REGALIA at 12% @ 1 fl oz=3.5 grams a.i. per cwt. MBI-110 is a commercial product with the trade name Amplitude which is a seed treatment.

### Example 3

Tables 3 and 4 below show evaluations of the compositions contemplated in this disclosure and their application rates. The results will demonstrate significantly improved insecticide and/or plant growth promotor on any treated plants, seeds, or plants grown from treated seeds. Redigo Pro is a commercial fungicide and is a trade name.

TABLE 3

| Trt | | | Core | Core |
|---|---|---|---|---|
| # | Timing | Base Treatment | treatments | treatment rate |
| 1 | A | Redigo Pro 67 ml/100 kg | Untreated | |
| 2 | A | Redigo Pro 67 ml/100 kg | SAT-WWF40 | 100 mL/100 kg |
| 3 | A | Redigo Pro 67 ml/100 kg | SAT-MB306 | 10 mL/100 kg |
| 4 | A | Redigo Pro 67 ml/100 kg | SAT-MB306 + | 10 mL + |
| | | | UBP-140 | 80 mL/100 kg |
| 5 | A | Redigo Pro 67 ml/100 kg | SAT-MB306 + | 20 mL + |
| | | | UBP-140 | 80 mL/100 kg |
| 6 | A | Redigo Pro 67 ml/100 kg | SAT-MB306 | 80 mL/100 kg |

TABLE 4
MBI306 10 ml/100 kg
MBI306 10 ml/100 kg + UBP 80 ml/100 kg
MBI306 20 ml/100 kg + UBP 80 ml/100 kg
MBI306 40 ml/100 kg
MBI306 40 ml/100 kg + UBP 80 ml/100 kg
MBI306 80 ml/100 kg

Colby's Analysis

The Colby Analysis is described by Colby, S. R. to calculate synergistic and antagonistic responses of herbicide combinations. See Weeds 15 (1967), pp. 20-22. Sometimes it is used on insecticides. It is based upon an expected level of control from mixing two or more herbicides together. The equation: E=(X*Y)/100, where X and Y are the effects of the herbicides applied alone (expressed as percent-of-control). For example, if X=50% and Y=40% of control, then, E=(50*40)/100 (50*40)/100, or 20% of control. The actual value for the herbicide mixture is then compared to the ‘expected’ value, and if greater than 1=synergism, if less than 1=antagonism, and if equal to 1=additive.

Burkholderia sp. A396, also known as Burkholderia rinojensis A396 was previously deposited with the Patent Depository of the National Center for Agricultural Utilization Research Agricultural Research Service, U.S. Department of Agriculture, 1815 North University Street, Peoria, Ill. 61604 U.S.A. on Sep. 15, 2009, and assigned NRRL No. B-50319. This deposit will be maintained under the terms of the Budapest Treaty on the International Recognition of the Deposit of Microorganisms for the Purposes of Patent Procedure. This deposit was made merely as a convenience for those of skill in the art and are not an admission that a deposit is required under 35 U.S.C. § 112.

It is contemplated that any embodiment discussed in this specification can be implemented with respect to any method, kit, reagent, or composition of the invention, and vice versa. Furthermore, compositions of the invention can be used to achieve methods of the invention.

It will be understood that embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. An improved insecticidal and/or plant growth promoting combination composition comprising
(a) a whole cell broth, filtrate, supernatant, and/or extract collected from fermentation of Burkholderia sp.;
(b) CPFAPH; and,
(c) one or more of carrier, diluent, and/or adjuvant;
wherein said improved insecticidal and/or plant growth promoting properties are compared with insecticidal and/or plant growth promoting properties of either (a) or (b) alone.

2. The improved insecticidal and/or plant growth promoting combination composition of claim 1, wherein said Burkholderia sp. is Burkholderia sp. A396.

3. The improved insecticidal and/or plant growth promoting combination composition of claim 1, wherein said Burkholderia sp. is Burkholderia sp. A396 having NRRL Accession No. B-50319.

4. The improved insecticidal and/or plant growth promoting combination composition of claim 1, wherein said composition is formulated as any one of the following formulation types: emulsifiable concentrate (EC), aqueous emulsion (EW), microemulison (ME), suspension concentrate (SC), oil dispersion (OD), capsule suspension (CS), wettable powder (WP), water dispersible granule (WDG), soluble powder (SP), soluble granule (SG), suspension emulsion (SE), flowable concentrate for seed treatment (FS), aqueous solution (AS), and/or ready to use formulation.

5. The improved insecticidal and/or plant growth promoting combination composition of claim 1, further comprises one or more micronutrients comprising boron, cobalt, copper, iron, manganese, molybdenum, and/or zinc.

6. The improved insecticidal and/or plant growth promoting combination composition of claim 5 further comprises ethylenediamine tetraacetic acid.

7. The improved insecticidal and/or plant growth promoting combination composition of claim 1, further comprises one or more insecticides and/or plant growth promoting agents.

8. The improved insecticidal and/or plant growth promoting combination composition of claim 7, wherein said one or more insecticides comprise Bacillus sp., Pseudomonas sp., Brevabacillus sp., Lecanicillium sp., non-Ampelomyces sp., Pseudozyma sp., Streptomyces sp., Burkholderia sp., Trichoderma sp., Gliocladium sp., paraffinic oil, tea tree oil, lemongrass oil, clove oil, cinnamon oil, citrus oil, rosemary oil, avermectin, Bacillus thuringiensis, neem oil, azadiractin, spinosads, Chromobacterium subtsugae, eucalyptus extract, Beauveria bassiana, Metarrhizium anisopliae, organophosphorous compounds, carbamates, pyrethroids, neonicotinoids, fenamiphos, aldicarb, oxamyl, carbofuran, avermectin, Paecilomyces lilacinas, Muscodor spp., Bacillus firmus and/or Pasteuria penetrans.

9. The improved insecticidal and/or plant growth promoting combination composition of claim 7, wherein said one or more plant growth promoting agents comprise diammonium phosphate, compost teas, seaweed extracts, indole acetic acid, indole butyric acid, naphthalene acetic acid, Pink Pigmented Facultative Methylotrophs, Bacillus spp., Pseudomonads sp., Rhizobia sp., and/or Trichoderma sp.

10. A method to improve insecticidal and/or plant growth promoting property of a plant and/or seed comprising the step of
applying to said plant and/or seed an effective amount of any of the combination compositions of claim 1.

11. The method to improve insecticidal and/or plant growth promoting property of a plant and/or seed of claim 10, where the method further comprises planting said seeds.

12. The method to improve insecticidal and/or plant growth promoting property of a plant and/or seed of claim 11, where the method further comprises growing said seeds.

13. The method to improve insecticidal and/or plant growth promoting property of a plant and/or seed of claim 10, where the method further comprises applying one or more insecticides to said plants and/or seeds.

14. The method to improve insecticidal and/or plant growth promoting property of a plant and/or seed of claim 13, where said one or more insecticides comprises Bacillus sp., Pseudomonas sp., Brevabacillus sp., Lecanicillium sp., non-Ampelomyces sp., Pseudozyma sp., Streptomyces sp., Burkholderia sp., Trichoderma sp., Gliocladium sp., paraffinic oil, tea tree oil, lemongrass oil, clove oil, cinnamon oil, citrus oil, rosemary oil, avermectin, Bacillus thuringiensis, neem oil, azadiractin, spinosads, Chromobacterium subtsugae, eucalyptus extract, Beauveria bassiana, Metarrhizium anisopliae, organophosphorous compounds, carbamates, pyrethroids, neonicotinoids, fenamiphos, aldicarb, oxamyl, carbofuran, avermectin, Paecilomyces lilacinas, Muscodor spp., Bacillus firmus and/or Pasteuria penetrans.

15. The method to improve insecticidal and/or plant growth promoting property of a plant and/or seed of claim 10, where the method further comprises applying one or more plant growth promoting agents to said plants and/or seeds.

16. The method to improve insecticidal and/or plant growth promoting property of a plant and/or seed of claim 15, where said one or more plant growth promoting agents comprises diammonium phosphate, compost teas, seaweed extracts, indole acetic acid, indole butyric acid, naphthalene acetic acid, Pink Pigmented Facultative Methylotrophs, Bacillus spp., Pseudomonads sp., Rhizobia sp., and/or Trichoderma sp.
